(19) United States
(12) Patent Application Publication
(10) Pub. No.: US 2013/0186384 A1
(43) Pub. Date: Jul. 25, 2013

(54) Temperature Enhancing Air Plenum

(71) Applicant: Thomas Russell King, Lompoc, CA (US)

(72) Inventor: Thomas Russell King, Lompoc, CA (US)

(21) Appl. No.: 13/357,163

(22) Filed: Jan. 24, 2012

(51) Int. Cl. A47J 37/07; F23H 17/08

(52) U.S. Cl. 126/30; 126/152 B

(57) ABSTRACT

A metal air plenum fitted to the inside walls of a solid fuel burning barbeque grill to provide lower temperatures of the outside walls of the grill and provide temperature enhancement of the flame at the heat source.

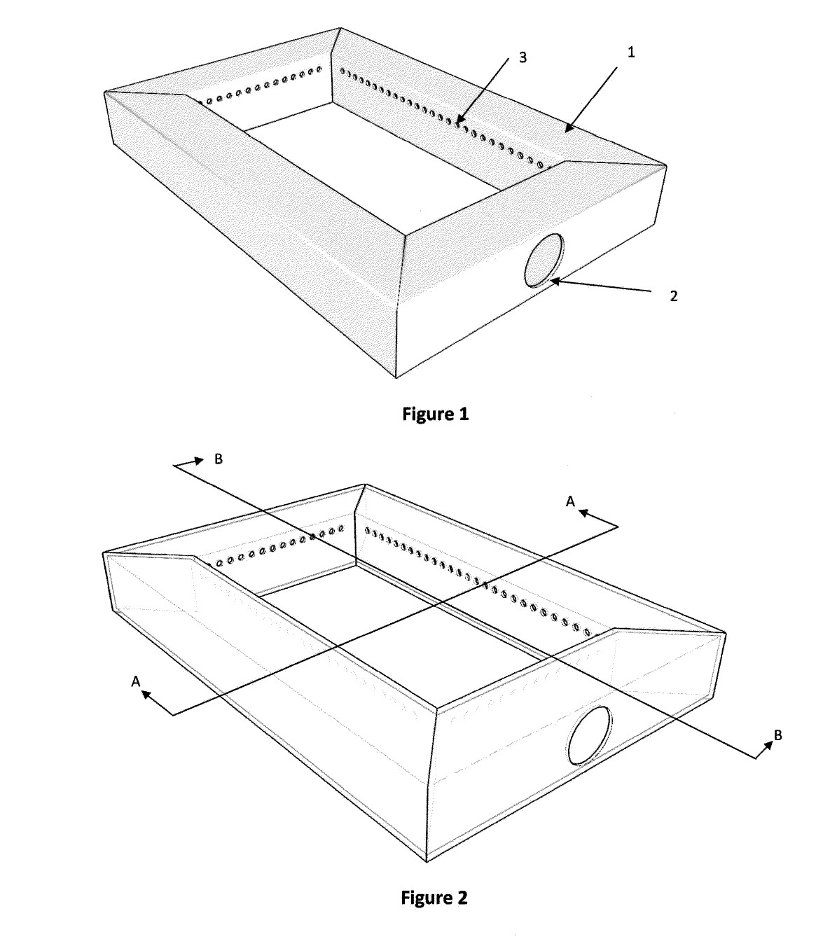

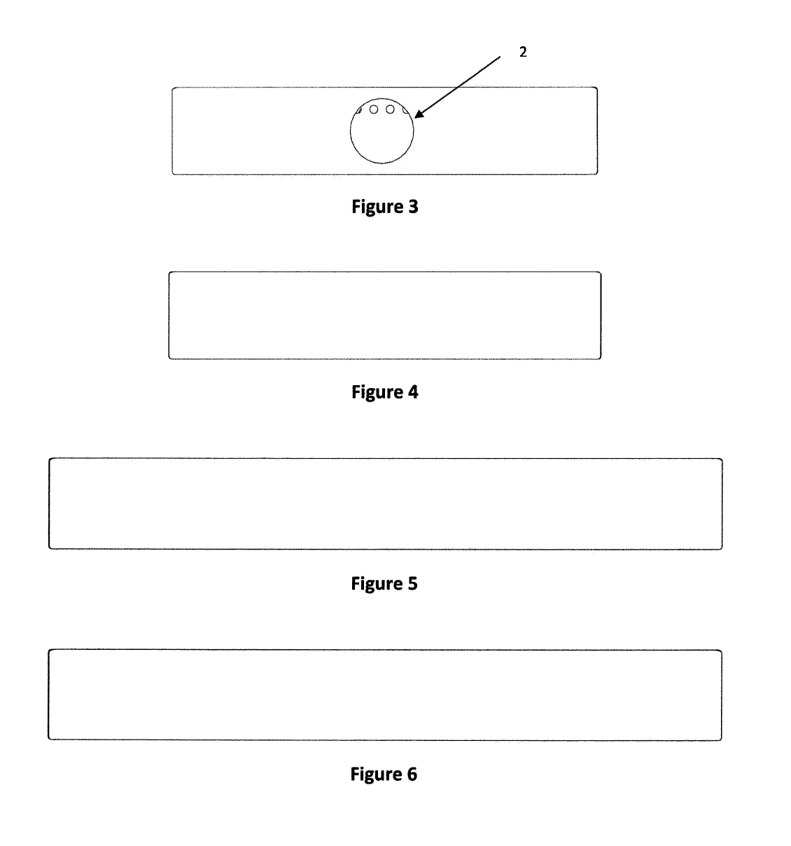

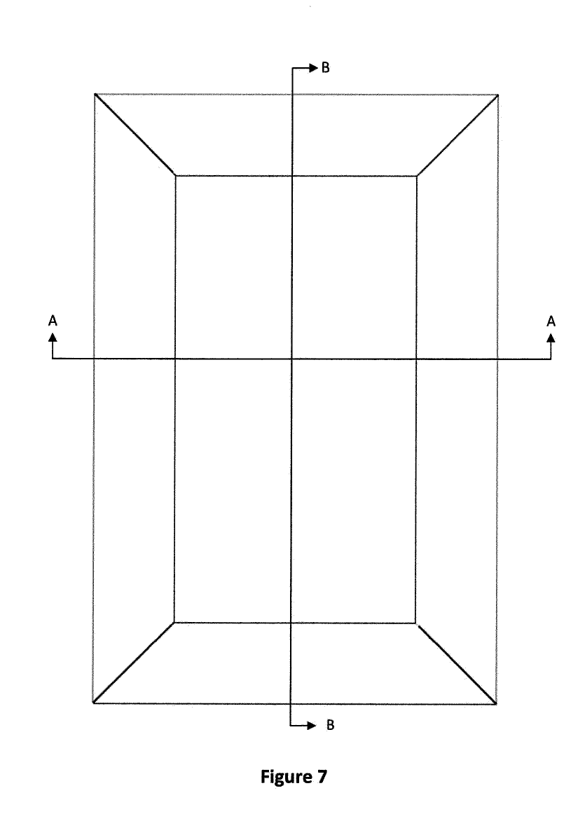

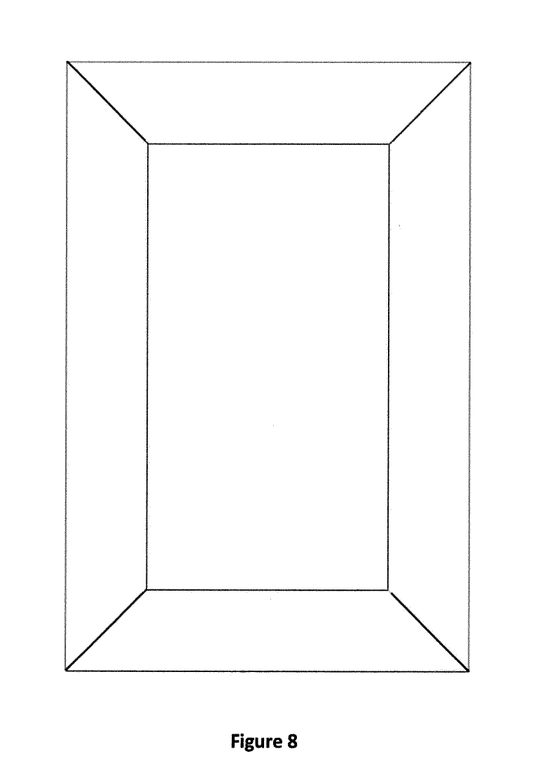

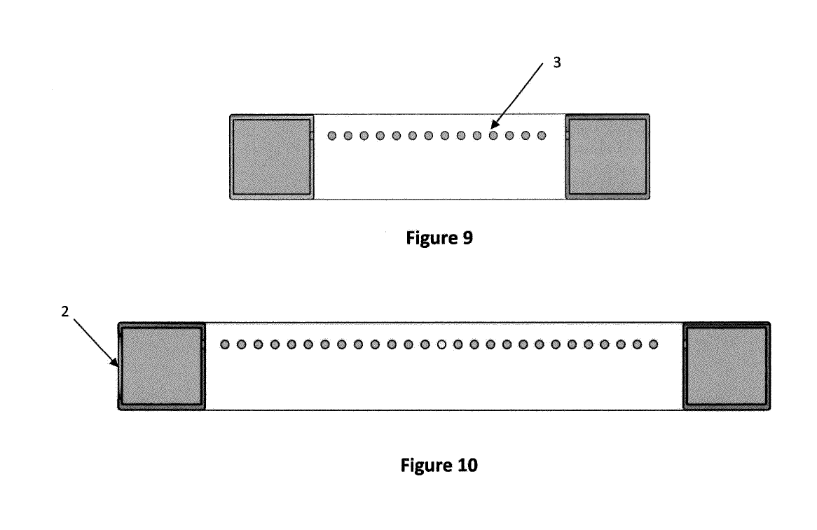

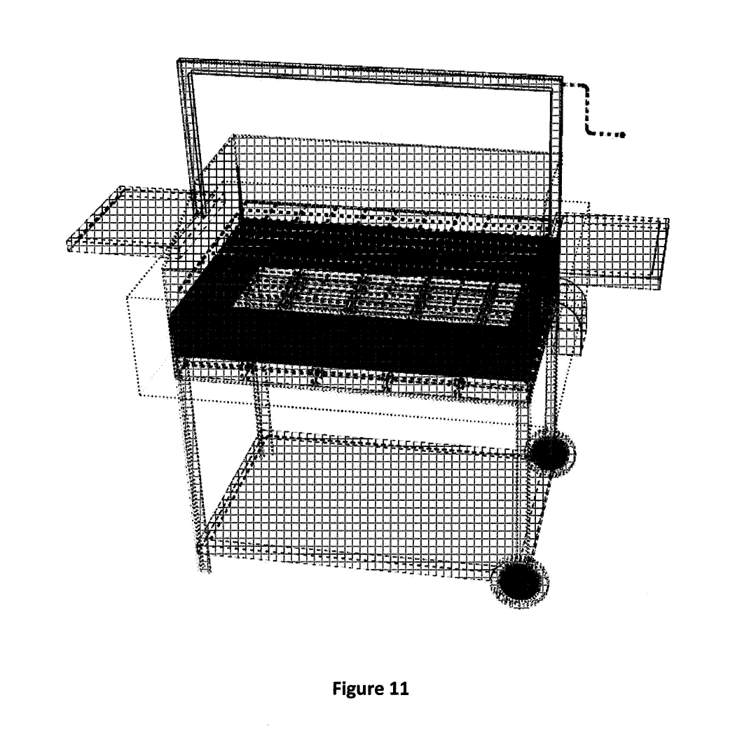

Background: When operating open pit barbeque grills that burn wood and other solid fuels, the exterior sides of the grill can get extremely hot and tend to burn out over a period of time from metal fatigue. The use of a metal air plenum on the inside walls of the grill helps in many ways, some of which are:

1. The embodiment becomes an insulating wall between the heat source and the exterior walls of the grill

2. The embodiment allows for cooler air to be brought in from outside the firebox and circulated around the interior walls of the grill lowering the temperature on the grills exterior walls

3. Air entering through the small air holes on the inside of the embodiment facing the heat source keep heat away from the outside walls of the grill and provide temperature enhancement of the heat source

The embodiment is a metal air plenum made of rectangular tubes (1) fitted to the inside walls of an open pit grill. Although there are many ways to get the cooler outside air into the embodiment, the way shown in this application is to cut a hole through the side wall of the grill to match up with the inlet supply air hole in the back side of the embodiment (2). This allows the outside air to flow through the wall of the grill and into the embodiment. The air moves from the outside of the grill into and through the embodiment around the heat source by convection and/or with the use of an electric blower. The interior side of the embodiment facing the heat source has small air holes (3) evenly spaced all the way around the embodiment. These air holes help keep the heat away from the exterior wall of the grill and provide for better temperature control for the flames at the heat source. This system can also be used on enclosed grills and ovens.

1. I claim air plenum for temperature enhancement of the interior and exterior of open pit Barbeques.
